(19) United States
(12) Patent Application Publication
(10) Pub. No.: US 2019/0353196 A1
(43) Pub. Date: Nov. 21, 2019

(54) FLOATING, CAPTIVE ARRANGEMENT OF A CONNECTION ELEMENT ON A COMPONENT

(71) Applicant: Heiko Schmidt, Lappersdorf (DE)

(72) Inventor: Heiko Schmidt, Lappersdorf (DE)

(21) Appl. No.: 16/412,987

(22) Filed: May 15, 2019

(30) Foreign Application Priority Data
May 17, 2018 (DE) 10 2018 111 959.3

(51) Int. Cl. F16B 37/04; F16B 33/00; F16B 5/02

(52) U.S. Cl. CPC F16B 37/044; F16B 39/12; F16B 5/025; F16B 33/002

(57) ABSTRACT

The invention relates to a floating, captive arrangement of a connection element on a component made of a sheet metal material, in which the connection element extends along a longitudinal axis (LA) and has at least a head section and a shaft section adjoining thereto along the longitudinal axis, which shaft section is set back relative to the head section in which the shaft section is passed, at least in sections, through a through-opening in the component and is connected, at least in the area of the free end of the shaft section opposing the head section, to a retaining plate element in such a way that the connection element is floatingly and captively arranged on the component, wherein the shaft section and/or the retaining plate element have/has respective locking means, which interact with corresponding locking means provided in the area of the through-opening of the component in such a way that the connection element received, at least in sections, in the through-opening of the component is secured against at least section-wise twisting about the longitudinal axis (LA) relative to the component.

### CROSS REFERENCE TO RELATED APPLICATION

This application is based on and claims the benefit of priority from German Patent Application No. DE 10 2018 111 959.3, filed on May 17, 2018, the contents of which are incorporated herein by reference.

### BACKGROUND OF THE INVENTION

### 1. Field of the Invention

The invention relates to a floating, captively secured arrangement of a connection element on a component.

### 2. Description of the Related Art

In the field of joining technology, for numerous applications it is necessary to secure a preferably threaded connection element, such as a nut, on a component surface. In order to achieve a tolerance compensation in terms of the bolting point in and with respect to the component surface, preference is given to a floating arrangement of the connection element on the component surface. For example, a typical assembly situation concerns a component that can only be accessed on one side, for which a floating arrangement of a connection element is required on the non-accessible component surface.

To this end, use is made of, for example, connection elements with a cage-like mounting made of a preferably sheet metal material, in which the connection element is received in the cage-like mounting made of a permanently deformable sheet metal material and via which said element is arranged floatingly on the component surface or in a pre-perforation or drilled hole provided therein.

Threaded connection elements of such design are commonly also known as “cage nut elements” or “cage nuts”. A tolerance compensation of the bolting point is achieved in the x/y direction; i.e., in the plane of the component surface, by means of such cage nuts. The cage of such cage nuts is commonly produced as a stamped part and welded onto a plate element. A smaller nut element, which is movable in the x and y directions or in the plane of the component surface, is enclosed in this cage. A disadvantage lies in the fact that the production of the cage and the welding of the same on the plate element is both labor- and cost-intensive, especially since this assembly is generally performed manually. Furthermore, such cage nuts are heavy and consequently require a large quantity of material.

### SUMMARY OF THE INVENTION

Given this background, the object of the invention is to specify a floating and captive arrangement of a connection element on a component, which furthermore comprises anti-twist locking and can be produced without requiring large amounts of material and time. The object is achieved by the features of claim 1.

One of the key aspects of the floating, captively secured arrangement according to the invention lies in the fact that the connection element extends along a longitudinal axis and has at least a head section and a shaft section adjoining thereto along the longitudinal axis, which shaft section is set back relative to the head section, that the shaft section is passed, at least in sections, through a through-opening in the component and is connected, at least in the area of the free end of the shaft section opposite the head section, to a retaining plate element in such a way that the connection element is floatingly and captively arranged on the component, wherein the head section and/or the retaining plate element each have locking means that interact with corresponding locking means of the component provided in the area of the through-opening of the component in such a way that the connection element, which is received, at least in sections, in the through-opening of the component, is secured against at least section- wise twisting about the longitudinal axis relative to the component. The component is thus preferably received between the head section of the connection element and the retaining plate element. The assembly effort and the quantity of material required for such a floating, captive and twist-proof arrangement of a connection element on a component can thus be substantially reduced in a particularly advantageous manner. In particular, the arrangement according to the invention can be produced in a fully automated fashion, thereby achieving a considerable cost savings compared to a manual assembly of the cage in the case of cage nuts. Power consumption and environmental pollution can also be cut back by omitting weld connections.

Another advantage is that the retaining plate element preferably produced from a sheet metal material has a through-opening, the diameter and/or cross-sectional shape of which is adapted, at least in sections, to the diameter and/or to the cross-sectional shape of at least the free end of the shaft section of the connection element. A captive arrangement of the retaining plate element on the free end of the connection element is thus achieved.

In a preferred embodiment variant, the retaining plate element is secured against at least section-wise twisting about the longitudinal axis of the connection element, on the free end of the shaft section of the connection element.

Another advantage is that the retaining plate element has an outer contour and/or outer dimensions that block a passing through of the retaining plate element through the through-opening of the component. The connection element is thus secured, at least via the head section on a free end and via the retaining plate element arranged on the opposite free end, from falling out or from being pressed out of the through-opening in the component.

Another advantage is that the retaining plate element is arranged slidably along the longitudinal axis on the shaft section of the connection element. As an alternative or in addition, the free end of the shaft section is received in the through-opening of the retaining plate element in such a way that the free end springs back from the underside of the retaining plate element into the through-opening. The retaining plate element is thus advantageously secured against at least section-wise twisting about the longitudinal axis of the connection element, on the free end of the shaft section of the connection element. Advantageously, it is thus possible to introduce a pre-tensioning as the arrangement according to the invention is screwed to a further component; specifically, the connection element, the component, the retaining plate element and the further component can be clamped together along the longitudinal axis or a pre-tensioning can be introduced via the torque of the screwing means. The retaining plate element is preferably attached to the shaft section of the connection element in such a way that when the torque is introduced, the retaining element can be slid along the shaft section with a force that is still less than the pre-tensioning force required to produce the final screw connection. Particularly advantageously, the arrangement of the invention composed of the connection element, the component and the retaining plate element can be pre-tensioned in a problem-free manner via a suitable tensioning means, for instance a screw element.

In a preferred embodiment variant of the invention, the free end of the shaft section of the connection element is received entirely in the through-opening of the retaining plate element and does not protrude beyond the underside of the retaining plate element. The underside of the retaining plate element thus advantageously forms a plane abutment surface. The free end of the shaft section preferably springs back from the underside into the through-opening of the retaining plate element and thus forms a tolerance gap, which makes it possible to introduce a pre-tensioning in the arrangement according to the invention in the case of assembly.

The locking means of the shaft section are advantageously formed by at least one locking section of the shaft section of the connection element, which section has a cross-sectional shape deviating from the circular shape.

Another advantage is that the locking means of the retaining plate element are formed by at least one locking section provided on the retaining plate element, or by a locking section configured as a part thereof having a cross-sectional shape deviating from the circular shape.

In the aforementioned embodiment variants, the corresponding locking means are each formed by a cross-sectional shape of the through-opening of the component that differs from the circular shape.

Particularly advantageously, the cross-sectional shape of the individual locking section and the cross-sectional shape of the through-opening are selected in such a way that the cross-sectional shapes brace one another when a locking section is received in the through-opening and when a screwing torque is applied to the connection element.

In an embodiment variant, the at least one locking section can be formed in one piece or integrally with the shaft section of the connection element. As an alternative, the at least one locking section can be formed in multiple parts and can have, specifically, a first and second part adjoining one another along the longitudinal axis. For example, the first part adjoins the head section directly and the subsequent second part is configured with a slightly tapered cross section in comparison thereto so as to give rise to a stepped transition between the first and second part, which forms an annular abutment surface. For example, when the retaining plate element abuts on the annular abutment surface when a screwing means is introduced into the connection element or the nut element, the component can be clamped between the head section and the retaining plate element, or a respective pretension can be applied.

In an alternative embodiment variant, the locking section is formed by at least one sleeve-like shaft section projecting outwardly away from the upperside of the retaining plate element, which shaft section is preferably formed in one piece or integrally with the retaining plate element.

Also advantageous is the fact that the cross-sectional shape of the locking section and/or the cross-sectional shape of the sleeve-like shaft section deviate(s) from the circular shape and specifically is/are square, rectangular, polygonal, triangular, oval or star-shaped.

Advantageously, the connection element is configured as a threaded connection element, in particular a nut element, and the through-opening in the component and/or the through-opening in the retaining plate element is/are formed by a pre-perforation or a drilled hole.

Another advantage is that a plurality of nose-like material projections arranged on the end face can be provided on the free end of the shaft section of the connection element and that a plurality of corresponding recesses can be provided on the underside of the retaining plate element, which recesses are opened towards the through-opening and in which the nose-like material projections can be plastically deformed to produce an anti-twist lock.

The subject matter of this invention is also a prefabricated assembly comprising an arrangement according to the invention, in which the component has a planar bead, in which the through-opening is arranged.

In the context of the invention, the expressions “approximately”, “substantially/essentially” or “roughly” mean deviations of +/−10%, preferably +/−5% from the respective exact values and/or deviations in the form of modifications of no significance for the function.

Further developments, advantages and possible uses of the invention also arise from the following description of exemplary embodiments and from the figures. All described and/or illustrated features, alone or in any combination, are in principle subject matter of the invention, independently of the summarization thereof in the claims or the back references thereof. The content of the claims also constitutes a component of the description.

### BRIEF DESCRIPTION OF THE DRAWINGS

The invention is explained in more detail in the following, with reference to the figures and exemplary embodiments. Shown are:

FIG. 1 by way of example, a schematic longitudinal section through a floating, captively secured arrangement of a connection element on a component according to the invention,

FIG. 2 by way of example, a schematic longitudinal section through a connection element configured as a nut element,

FIG. 3 by way of example, a schematic plan view of the underside of a retaining plate element,

FIG. 4 by way of example, a schematic plan view of the upperside of the component fabricated from a sheet metal material,

FIG. 5 by way of example, a schematic lateral view of a connection element having a one-piece locking section,

FIG. 6 by way of example, a schematic lateral view of a connection element having a two-piece locking section,

FIG. 7 by way of example, a schematic view of the underside of a connection element having a variant of a one-piece locking section,

FIG. 8 by way of example, a schematic view of the underside of a connection element having an alternative variant of a one-piece locking section,

FIG. 9 by way of example, a schematic view of the underside of a connection element having a variant of a two-piece locking section,

FIG. 10 by way of example, a schematic lateral view of a retaining plate element having a locking section in the form of a sleeve-like flange,

FIG. 11 by way of example, a schematic view of the underside of the retaining plate element according to FIG. 10,

FIG. 12 by way of example, a lateral longitudinal section through an arrangement according to the invention in the form of a prefabricated assembly,

FIG. 13 by way of example, an attachment of an arrangement according to the invention in the form of a prefabricated assembly to a further component.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

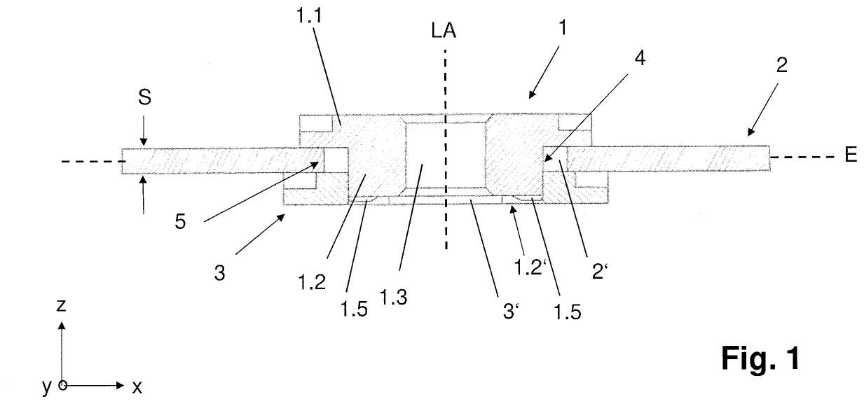

By way of example, FIG. 1 shows an arrangement according to the invention of a connection element 1 on a component 2 fabricated from a sheet material, in which the connection element 1 is both floatingly and captively arranged on the component 2. The component 2 can be made of metal or plastic, for example.

The component 2 is preferably formed by a panel-like component or by a panel-like workpiece having an assembly area that is planar, at least in sections.

To make the arrangement according to the invention clearer, in individual figures a Cartesian coordinate system comprising an x-axis, a y-axis and a z-axis is sketched in. The sheet metal component 2 herein extends at least in the connection area along a plane E, which runs parallel to a plane defined by the x-axis and the y-axis. The connection element 1 furthermore extends along a longitudinal axis LA, which runs parallel to the z-axis.

In the context of the invention, a captive arrangement of the connection element 1 on the component 2 is understood to mean a fastening of the connection element 1 in or on the component 2, by means of which the connection element 1, in the assembled state, is secured against loss and/or against being pressed out. To this end, the connection element 1 is preferably passed, at least in sections, through a through-opening 2′ provided in the component 2 and is in particular secured against being pressed out of this through-opening 2′ of the component 2 along the z-axis. The through-opening 2′ is formed, for example, by a pre-perforation or by a corresponding drilled hole in the component 2.

In the context of the invention, a floating arrangement of the connection element 1 on the component 2 is understood to mean an attachment of the connection element 1 on the component 2, which attachment is at least slidable or movable along plane E of the component 2, i.e., in the x-direction and/or y-direction. In addition, at least a slight slidability along the z-axis can be provided. Owing to the resulting movability or slidability relative to the component 2 of the connection element 1 passed in sections through the through-opening 2′, a tolerance compensation is possible during the assembly of the component 2 using the connection element 1 mounted thereon.

In this exemplary embodiment, the connection element 1 is formed by a threaded connection element, in particular a nut element. However, the invention is not in any way limited to a nut element; screw elements or bolt elements can also be floatingly and captively arranged in the component 2.

In the arrangement depicted in FIG. 1, the connection element 1 extends along the z-axis; i.e., in the assembled state the longitudinal axis LA thereof extends approximately perpendicular to the plane E of the component 2, but at least to the plane E of the assembly area of the component 2. The connection element 1 furthermore has at least one head section 1.1 and a shaft section 1.2, which adjoins the head section 1.1 along the longitudinal axis LA and is set back in the direction of the longitudinal axis LA with respect to the head section 1.1. The outer or shell surfaces of the head section 1.1 and of the shaft section 1.2 thus have a different radial extension with respect to the longitudinal axis LA in order to block a passing of the head section 1.1 through the through-opening 2′ in the component 2.

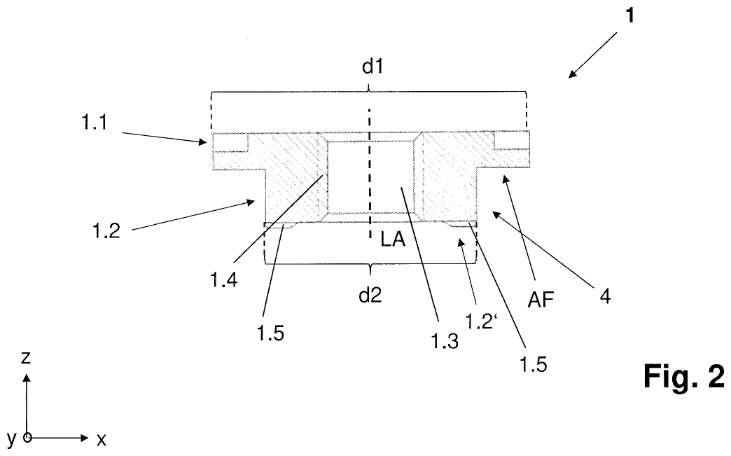

A schematic longitudinal section along the longitudinal axis LA through a connection element 1 configured as a nut element is illustrated by way of example in FIG. 2. The connection element or nut element 1 has, for example, a throughbore 1.3 extending along the longitudinal axis LA with a female thread 1.4, which throughbore preferably extends concentrically to the longitudinal axis LA completely through the head section 1.1 and shaft section 1.2 of the nut element 1. The diameter d1 of the head section 1.1 exceeds, at least in sections, the diameter d2 of the shaft section 1.2, giving rise to a stepped transition between the head and shaft sections 1.1, 1.2. An essentially annular, preferably plane abutment surface AF, which preferably runs parallel to the upperside of the head section 1.1 and concentrically around the longitudinal axis LA, is thus formed on the underside of the head section 1.1.

For the floating and captive arrangement of the connection element 1 or nut element on the component 2, according to the invention a retaining plate element 3 is provided, which is preferably made of a sheet metal material. The retaining plate element 3 is disc-shaped, preferably washer-shaped, for example.

The retaining plate element 3 furthermore has a through-opening 3′, which is preferably arranged in the center of the retaining plate element 3, the diameter d3 and/or cross-sectional shape of which are/is adapted, at least in sections, to the diameter d2 and/or the cross-sectional shape of at least the free end 1.2′ of the shaft section 1.2 of the connection element 1.

The retaining plate element 3 is furthermore configured, in particular in terms of the outer dimensions and/or outer contour thereof, in such a way that the retaining plate element 3 connected to the free end 1.2′ of the shaft section 1.2 cannot be passed through the through-opening 2′ of the component 2. For example, the outer dimensions of the retaining plate element 3 exceed, at least in sections, the maximum opening width bm of the through-opening 2′ of the component 2.

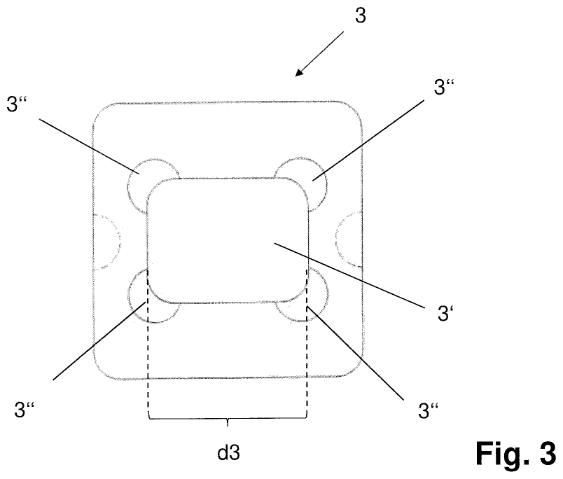

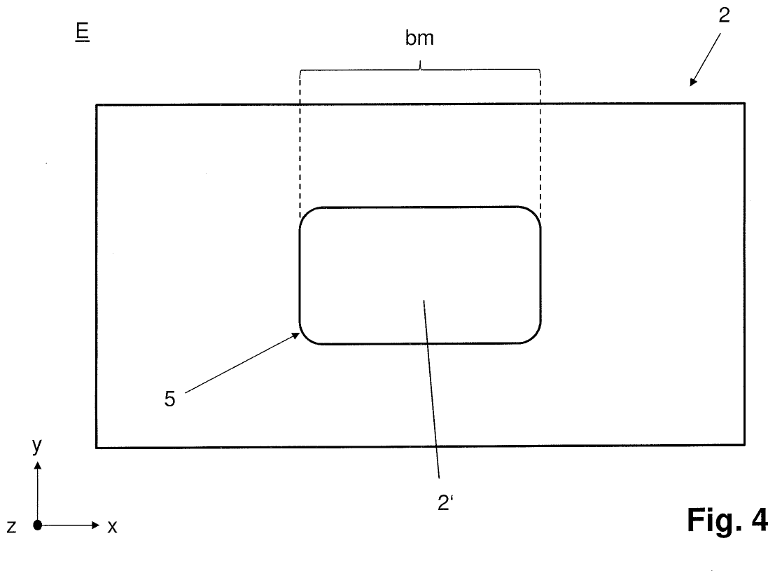

By way of example, FIG. 3 shows a schematic view of the underside of the retaining plate element 3 shown in FIG. 1, and a plan view of an embodiment variant of a component 2 is shown by way of example in FIG. 4, which component can be formed by a metal sheet part and can have essentially any outer contour. In this exemplary embodiment, the component or metal sheet part 2 has a component thickness S and is rectangular in a view from above.

As shown by way of example in FIG. 1, the shaft section 1.2 of the connection element 1 is passed in sections through the through-opening 2′ in the component 2 and connected, at least in the area of the free end 1.2′ of the shaft section 1.2 opposite the head section 1.1, to the retaining plate element 3 in such a way that the connection element 1 configured as a nut element is floatingly and captively arranged on the component 2. For this, the edge area of the free end of the connection element 1 and/or the edge area of the through-opening 3′ are each deformed, at least in sections, plastically outwards or inwards, respectively, such that the retaining plate element 3 is connected in a force- and/or form-fitting manner in the area of the through-opening 3′ to the free end 1.2′ of the shaft section 1.2 of the connection element 1. As an alternative, use can be made of a press fit for the connection. The connection of the free end 1.2′ of the shaft section 1.2 to the retaining plate element 3 is preferably made in such a way that the free end 1.2′ of the shaft section 1.2 is received completely in the through-opening 3′ of the retaining plate element 3; i.e., it does not protrude beyond the underside of the retaining plate element 3. A level abutment surface formed by the underside of the retaining plate element 3 is thus still maintained, even after the establishment of the connection between the free end 1.2′ of the shaft section 1.2 and the retaining plate element 3.

According to the invention, the shaft section 1.2 and/or the retaining plate element 3 each have locking means 4, which interact with corresponding locking means 5 provided in the area of the through-opening 2′ of the component 2 in such a way that the connection element 1 received, at least in sections, in the through-opening 2′ of the component 2 is secured against at least section-wise twisting about the longitudinal axis LA relative to the component 2. The connection element 1 is thus not only arranged in the component 2 or received in or fed through the through-opening 2′ of the component 2 in a floating and captively secured manner, but also, at least partially or in sections, in a twist-proof manner.

In a preferred embodiment variant, the locking means are formed by the configuration of at least one locking section 4 on the shaft section 1.2, wherein the cross-sectional shape of the locking section 4 is adapted to the cross-sectional shape of the through-opening 2′ in the component 2 in such a way that the shaft section 1.2 with the locking section 4 is received in the through-opening 2′ floatingly; i.e., slidably in the x- and y-directions, but only permits a slight twisting about the longitudinal axis LA; i.e., forms an anti-twist lock. For example, the opening 2′ or the cross-sectional shape thereof in the component 2 forms the corresponding locking means 5 according to the meaning of the invention. To this end, the cross section of the shaft section 1.2 and the through-opening 2′ have a cross-sectional shape that deviates from the circular shape, in other words they are configured as square, rectangular triangular, oval, polygonal and/or star-shaped, for example. In this exemplary embodiment according to FIGS. 1, 4 and 7, for example, the through-opening 2′ and the cross section of the shaft section 1.2 are configured as rectangular.

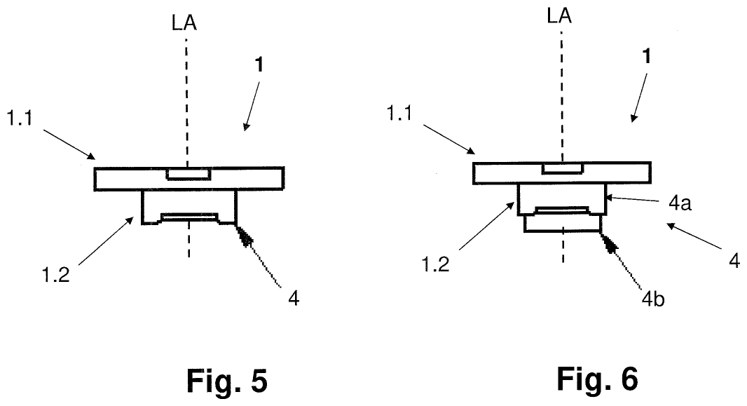

By way of example, FIG. 5 shows a schematic lateral view of a connection element 1 configured as a nut element, the locking section 4 of which is formed in one piece or integrally with the shaft section 1.2 of the connection element 1. Owing to the inventive selection of the cross sections, at least several areas of the locking section 4 are braced on areas of the corresponding locking section 5 when the connection element 1 is rotated about the longitudinal axis LA. The outer dimensions of the locking section 4 and the inner dimensions or the cross section of the corresponding locking section 5 are thus selected in such a way that, at least in sections, a gap is formed, which achieves the floating arrangement.

In an alternative embodiment according to FIG. 6, the locking section is formed in two parts, wherein the first part 4a of the locking section 4 directly adjoins the head section 1.1 of the connection element 1 and is formed by the shell surface of the shaft section 1.2. The second part 4b of the locking section 4 immediately follows the first part 4a along the longitudinal axis LA, wherein said second part can be configured as slightly tapered in cross section compared to said first part; in other words the shell surface of the second part 4b springs back toward the longitudinal axis LA with respect to the shell surface of the first part 4a of the locking section 4 and forms a stepped transition. This stepped transition area can serve as, for example, an annular abutment surface on which the edge area of the through-opening 3′ of the retaining plate element 3 comes in abutment or is braced against after a plastic deformation of the free end 1.2′ of the shaft section 1.2 or of the second part 4b and/or of the edge area of the through-opening 3′. For example, a defined distance can thus be set between the abutment surface AF of the head section 1.1 and the upperside of the retaining plate element 3. This distance at least slightly exceeds the material thickness S of the component 2 in order to achieve the floating arrangement.

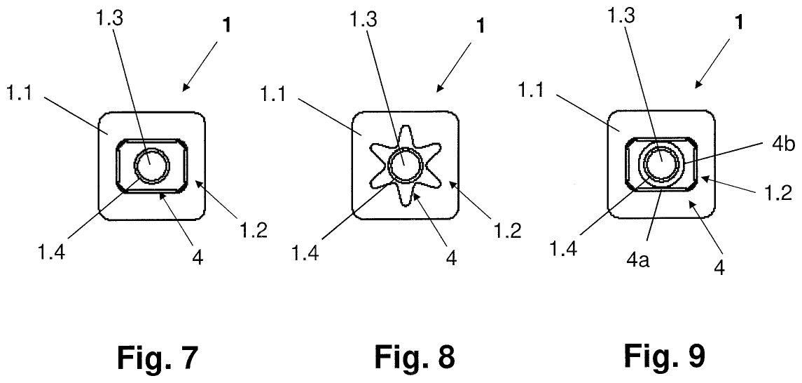

Further embodiment variants of the locking section 4 formed by the shaft section 1.2 of the connection element 1 are illustrated in FIGS. 7 and 8. Specifically, FIG. 7 shows a schematic plan view of a rectangular locking section 4, which in terms of its shape and dimensioning is adapted, for example, to the rectangular through-opening 2′ of the component 2 or to the corresponding locking means 5 illustrated in FIG. 4.

A schematic plan view of a locking section 4, which is star-shaped in cross section and which is formed by a corresponding configuration of the shell surface of the shaft section 1.2 of the nut element 2, is shown in FIG. 8. In analogous fashion, the associated through-opening 2′ of the component 2 (not illustrated in the Figures) and therefore the corresponding locking means 5 is also configured as star-shaped, although in such a way that a gap-like opening remains between the edge contour of the component 2 enclosing the through-opening 2′ and the shell surface of the shaft section 1.2 forming the locking section 4, which permits a floating movement of the connection element or nut element 1 received in the through-opening 2′.

FIG. 9 shows a schematic plan view of the underside or the end face of the shaft section 1.2 of the connection element or nut element 1 having a two-part locking section 4 according to FIG. 6. In this embodiment variant, the first part 4a of the locking section 4 is also rectangular in cross section, whereas the second part 4b, for example, is circular. In such an embodiment variant, the through-opening 3′ in the retaining plate element 3 could also be configured as, for example, circular and with a slightly enlarged diameter to allow the retaining plate element 3 to be put on and then connected to the second part 4b.

Alternatively or additionally, the locking section 4′ can be provided on the retaining plate element 3 or configured as a part thereof; specifically, said locking section is preferably formed by a sleeve-like shaft section 3.1, which is formed in one piece or integrally with the retaining plate element 3 and projects outwardly away from and is preferably perpendicular to the upperside of the retaining plate element 3. The cross-sectional shape of the sleeve-like shaft section 3.1 or locking section 4′ is in turn adapted to the cross-sectional shape of the through-opening 2′ in the component 2 in such a way that the sleeve-like shaft section 3.1 is received floatingly; i.e., slidably in the x- and y-directions, in the through-opening 2′, but permits only a slight twisting about the longitudinal axis LA; i.e., an anti-twist locking of the retaining plate element 3 relative to the component 2 is formed. If the retaining plate element 3 is likewise connected in a twist-proof manner to the connection element 1 (as described in the preceding), then an anti-twist locking of the connection element 1 is likewise provided. To provide an anti-twist lock, this locking section 4′ thus interacts, analogously to the exemplary embodiment described in the preceding, with the corresponding locking section 5 formed by the through-bore 2′ in the component. The sleeve-like shaft section 3.1 has a through-bore 3.1′, which continues into the retaining plate element 3 and forms the through-opening 3′ therein.

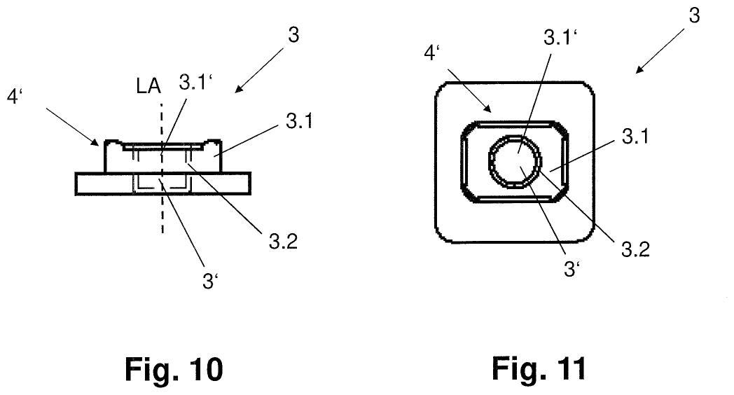

By way of example, a retaining plate element 3 configured in this manner with a sleeve-like shaft section 3.1 is illustrated in FIGS. 10 and 11, wherein FIG. 10 shows a schematic lateral view of the retaining plate element 3 and FIG. 11 shows a schematic plan view of the upperside of the retaining plate element 3.

The through-bore 3.1′ and the adjoining through-opening 3′ are preferably circular and have a continuous female thread 3.2. This advantageously makes it possible to clamp the component 2 between the connection element 1 configured as a nut element and the retaining plate element 3 by introducing a suitable screw element.

The locking section 4′ and the sleeve-like shaft section 3.1 forming the same can also be configured as a separate component, which is connected accordingly in a twist-proof manner to the retaining plate element 3.

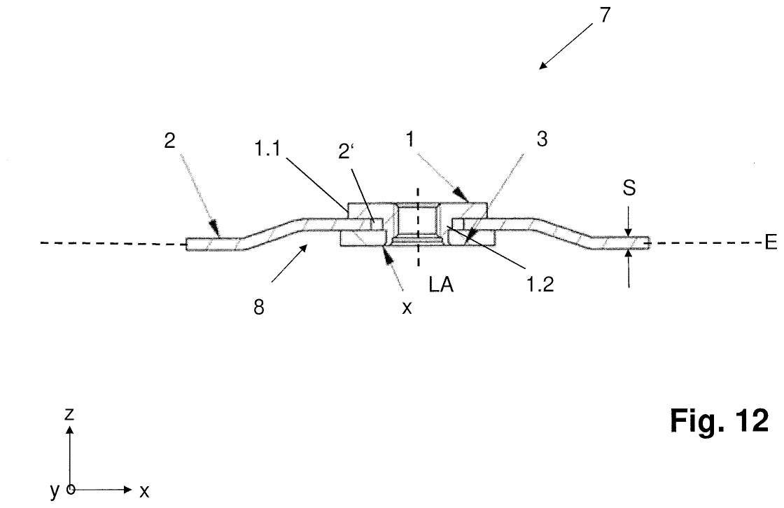

In another embodiment variant, the floating and captive arrangement according to the invention of a connection element 1 on a component 2 can form a prefabricated assembly 7 or pre-assembly. By way of example, a schematic longitudinal section through such an assembly 7 is illustrated in FIG. 12. The assembly or attachment area is situated in a planar bead 8 in the component 2, whereby the assembly area is offset parallel to the plane E of the component 2, specifically in such a way that the retaining plate element 3 is received therein. The bead 8 is formed in the component 2 before the connection element 1 is inserted in the through-opening 2′. By virtue of the countersunk arrangement of the retaining plate element 3 in the bead 8 preformed in the component 2, a sliding movement of the connection element 1 configured as, for example, a nut element, is effectively prevented.

Depending on the purpose and place of use, such an assembly 7 can be connected to a further component 6, which also has a through-opening 6′ which in the assembled state is preferably aligned with the through-opening 2′ of the component 2. The further component 6 extends, at least in the connection area, along the plane E, and the edge areas of the component 2 that enclose the bead 8 abut on the further component 6. The module 7 is preferably joined to the further component 6, specifically by means of welding, bonding, self-piercing riveting, blind riveting or clinching. In an alternative embodiment variant, the bead 8 can also be provided in the further component 6 and the component 2 comprising the arrangement according to the invention does not comprise a bead 8.

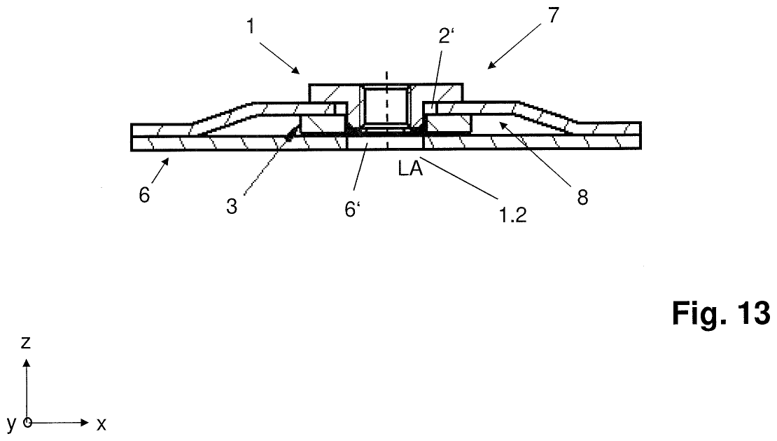

By way of example, an embodiment variant of an assembly 7 joined to a further component 6 is illustrated in FIG. 13. In the illustrated variant, a floating and captive arrangement of the connection element 1 is also achieved because the retaining plate element 3 is received in the bead 8 between both components 2, 6.

The component 2 can also be formed by a plastic component, which is received in the area of the through-opening 2′ between the head section 1.1 and the retaining plate element 3. With a two-part configuration of the shaft section 1.2 or of the locking section 4 partially formed by the same, a distance block can be realized by the stepped configuration thereof, which blocks the introduction of an excessive pre-tensioning force into the plastic component. In this case the length of the first part 4a of the shaft section 1.2 is adapted to the material thickness or component thickness S of the component 2.

The invention was described in the preceding with reference to exemplary embodiments. Obviously, numerous modifications and variations are possible without exceeding the underlying inventive concept of the invention.

### LIST OF REFERENCE SIGNS

1 Connection element, in particular nut element

1.1 Head section

1.2 Shaft section

1.2′ Free end

1.3 Through-bore

1.4 Female thread

1.5 Protruding material projections

2 Component

2′ Through-opening

3 Retaining plate element

3′ Through-opening

3″ Recesses

3.1 Sleeve-like shaft section

3.2 Female thread

4 Locking means or locking section

4′ Locking section on the retaining plate

4a First part

4b Second part

5 Corresponding locking means

6 Further component

6′ Through-opening

7 Prefabricated assembly

8 Bead

AF Abutment surface

bm Maximum opening width

d1 Diameter of the head section

d2 Diameter of the shaft section

d3 Diameter of the through-opening of the retaining plate element

E Plane of the component

LA Longitudinal axis

S Material thickness of the component

1. A floating, captively secured arrangement, comprising:
a connection element on a component produced from a sheet material, in which the connection element extends along a longitudinal axis and comprises at least a head section and a shaft section adjoining thereto along the longitudinal axis, which shaft section is set back relative to the head section, in which the shaft section is passed, at least in sections, through a through-opening in the component and is connected, at least in the area of the free end of the shaft section opposing the head section, to a retaining plate element in such a way that the connection element is floatingly and captively arranged on the component, wherein the shaft section and/or the retaining plate element has/have respective locking means which interact with corresponding locking means provided in the area of the through-opening of the component in such a way that the connection element, which is received at least in sections in the through-opening of the component, is secured against at least section-wise twisting about the longitudinal axis relative to the component.

2. The arrangement according to claim 1, wherein the component is received between the head section of the connection element and the retaining plate element.

3. The arrangement according to claim 1, wherein the retaining plate element is produced from a sheet metal material and has a through-opening, the diameter and/or the cross-sectional shape of which is adapted, at least in sections, to the diameter and/or to the cross-sectional shape of at least the free end of the shaft section of the connection element.

4. The arrangement according to claim 3, wherein the retaining plate element is secured against at least section-wise twisting about the longitudinal axis of the connection element at the free end of the shaft section of the connection element.

5. The arrangement according to claim 1, wherein the retaining plate element has an outer contour and/or outer dimensions that block a passing through of the retaining plate element through the through-opening of the component.

6. The arrangement according to claim 1, wherein the retaining plate element is arranged slidingly along the longitudinal axis on the shaft section of the connection element and/or that the free end of the shaft section is received in the through-opening of the retaining plate element in such a way that the free end springs back from the underside of the retaining plate element into the through-opening.

7. The arrangement according to claim 1, wherein the free end of the shaft section of the connection element is received completely in the through-opening of the retaining plate element and does not protrude beyond the underside of the retaining plate element.

8. The arrangement according to claim 1, wherein the locking means of the shaft section are formed by at least one locking section of the shaft section of the connection element, which locking section has a cross-sectional shape deviating from the circular shape.

9. The arrangement according to claim 1, wherein the locking means of the retaining plate element are formed by at least one locking section provided on or configured as part of the retaining plate element and having a cross-sectional shape deviating from the circular shape.

10. The arrangement according to claim 1, wherein the corresponding locking means are formed by a cross-sectional shape of the through-opening of the component that deviates from the circular shape.

11. The arrangement according to claim 8, wherein the cross-sectional shape of the individual locking section and the cross-sectional shape of the through-opening are selected in such a way that the cross-sectional shapes brace one another when a locking section is received in the through-opening and when a screwing torque is applied to the connection element.

12. The arrangement according to claim 8, wherein the at least one locking section is formed in one piece or integrally with the shaft section of the connection element.

13. The arrangement according to claims 8, wherein the at least one locking section is formed in multiple parts and has a first and second part adjoining one another along the longitudinal axis.

14. The arrangement according to claim 13, wherein the first part directly adjoins the head section and the subsequent second part is configured as slightly tapered in cross section compared to the first part such that a stepped transition between the first and second parts is formed, that provides an annular abutment surface.

15. The arrangement according to claim 9, wherein the locking section is formed by at least one sleeve-like shaft section projecting outwardly away from the upperside of the retaining plate element.

16. The arrangement according to claim 15, wherein the sleeve-like shaft section is formed in one piece or integrally with the retaining plate element.

17. The arrangement according to claim 8, wherein the cross-sectional shape of the locking section and/or the cross-sectional shape of the through-opening and/or the cross-sectional shape of the sleeve-like shaft section is/are square, rectangular, polygonal, triangular, oval or star-shaped.

18. The arrangement according to claim 1, wherein the connection element is configured as a nut element, a bolt element, or a screw element.

19. The arrangement according to claim 1, wherein the through-opening in the component and/or the through-opening in the retaining plate element is/are formed by a pre-perforation or by a drilled hole.

20. The arrangement according to claim 1, wherein a plurality of nose-like material projections arranged on the end face are provided on the free end of the shaft section of the connection element and a plurality of corresponding recesses are provided on the underside of the retaining plate element, which recesses are opened toward the through-opening and in which the nose-like material projections can be plastically deformed to produce an anti-twist lock.

21. A prefabricated assembly comprising an arrangement according to claim 1.

22. The prefabricated assembly according to claim 21, wherein the component is connected to a further component having a corresponding through-opening.
